(19) United States
(12) Patent Application Publication
(10) Pub. No.: US 2024/0294151 A1
(43) Pub. Date: Sep. 5, 2024

(54) METHOD AND SYSTEM TO COMPENSATE FOR BRAKE PEDAL EFFORT TO PEDAL TRAVEL CHANGE DUE TO TEMPERATURE IN AN ELECTRONICALLY CONTROLLED BRAKING SYSTEM

(71) Applicants: Hyundai Motor Company, Seoul (KR); Kia Corporation, Seoul (KR)

(72) Inventors: William K. Manosh, Palmdale, CA (US); Jun Mo Lee, Aliso Viego, CA (US); Lance McLaws, Tehahcapi, CA (US)

(21) Appl. No.: 18/176,548

(22) Filed: Mar. 1, 2023

(51) Int. Cl. B60T 8/172; B60T 8/171; B60T 17/22

(52) U.S. Cl. CPC B60T 8/172; B60T 8/171; B60T 17/22; B60T 2210/30; B60T 2220/04

(57) ABSTRACT

Systems and methods are provided for compensating for a change in a brake pedal effort to brake pedal travel relationship due to temperature in an electronically-controlled braking system is provided. The method may comprise performing, using a computing device of a vehicle, a sensing function when a function to decelerate the vehicle is applied. The sensing function may comprise measuring a pedal effort measurement, measuring a pedal travel measurement, and measuring a simulator temperature measurement of a pedal feel simulator. The method may comprise performing, using the computing device, a processing function. The processing function may comprise calculating a brake command, applying a correction to the brake command based on the simulator temperature measurement, generating a final brake command, and outputting the final brake command. The method may comprise performing, using the computing device, an actuation function based on the final brake command.

### BACKGROUND

### Technical Field

Embodiments of the present disclosure relate to systems and methods for compensating for brake pedal effort to travel change due to temperature in an electronically-controlled braking system.

### Background

When stopping a vehicle, pressure is applied to a brake pedal of the vehicle. However, the required pressure that needs to be applied to the brake pedal to stop a vehicle is not equal under all atmospheric conditions.

As temperature decreases, material property changes in the braking systems require additional pressure to be applied to the brake pedal in order to stop the vehicle. For example, as the temperature decreases, physical changes occur in the braking system including, but not limited to, elasticity changes for one or more components of the braking system, changes in the viscosity of brake fluid, and changes in the feeling spring or damper modulus, among others. For electronically-controlled braking systems, the effort needed to stop a vehicle increases as the temperature decreases.

Existing technologies utilize sensors for pedal effort and pedal travel generate a driver braking signal which may be input into a brake command calculation in order to create a final brake command that may be used by a brake actuation system in order to decelerate the vehicle. However, existing technologies do not incorporate a sensing mechanism for a simulator temperature and do not correct for simulator temperature variation. Existing technologies compensate for temperature-induced brake friction changes through various mechanisms and not simulator effort versus pedal travel change.

### SUMMARY

According to an object of the present disclosure, a method for compensating for a change in a brake pedal effort to brake pedal travel relationship due to temperature in an electronically-controlled braking system is provided. The method may comprise performing, using a computing device of a vehicle, a sensing function when a function to decelerate the vehicle is applied. The sensing function may comprise measuring a pedal effort measurement, using a pedal effort sensor, measuring a pedal travel measurement, using a pedal travel sensor, and measuring a simulator temperature measurement of a pedal feel simulator, using a simulator temperature sensor. The method may comprise performing, using the computing device, a processing function. The processing function may comprise calculating a brake command, applying a correction to the brake command based on the simulator temperature measurement, generating a final brake command, and outputting the final brake command. The method may comprise performing, using the computing device, an actuation function based on the final brake command.

According to an exemplary embodiment, the applying the correction to the brake command based on the simulator temperature measurement may comprise, using the computing device, combining the pedal effort measurement and the pedal travel measurement to determine a relationship between the pedal effort measurement and the pedal travel measurement.

According to an exemplary embodiment, the applying the correction to the brake command based on the simulator temperature measurement may comprise, using the computing device, determining whether the simulator temperature measurement is within a temperature action range, when the simulator temperature measurement is within the temperature action range, determining whether the relationship between the pedal effort measurement and the pedal travel measurement is within predetermined parameters, and, when the relationship between the pedal effort measurement and the pedal travel measurement is within the predetermined parameters, applying the correction to the brake command based on the simulator temperature measurement.

According to an exemplary embodiment, the applying the correction to the brake command based on the simulator temperature measurement may comprise, using the computing device, determining whether the simulator temperature measurement is within a temperature action range, when the simulator temperature measurement is within the temperature action range, determining whether the relationship between the pedal effort measurement and the pedal travel measurement is within predetermined parameters, when the relationship between the pedal effort measurement and the pedal travel measurement is within the predetermined parameters, determining whether a brake apply rate is within a tuned parameter, wherein the brake apply rate may be a rate at which a brake is applied, and, when the brake apply rate is within the tuned parameter, applying the correction to the brake command based on the simulator temperature measurement.

According to an exemplary embodiment, the actuation function may comprise performing one or more of a set of one or more physical operations required to decelerate the vehicle based on the final brake command.

According to an exemplary embodiment, the one or more physical operations may comprise applying a brake torque based on the final brake command.

According to an exemplary embodiment, the brake command may be a degree of braking a driver is requesting.

According to an object of the present disclosure, a system for compensating for a change in a brake pedal effort to brake pedal travel relationship due to temperature in an electronically-controlled braking system is provided. The system may comprise a vehicle. The vehicle may comprise a pedal effort sensor configured to measure a pedal effort measurement, a pedal travel sensor configured to measure a pedal travel measurement, a simulator temperature sensor configured to measure a simulator sensor measurement of a pedal feel simulator, and a processor configured to perform a sensing function when a function to decelerate the vehicle is applied. The sensing function may comprise measuring the pedal effort measurement, using the pedal effort sensor, measuring the pedal travel measurement, using the pedal travel sensor, and measuring the simulator temperature measurement, using the simulator temperature sensor. The processor may be configured to perform a processing function. The processing function may comprise calculating a brake command, applying a correction to the brake command based on the simulator temperature measurement, generating a final brake command, and outputting the final brake command. The processor may be configured to perform an actuation function based on the final brake command.

According to an exemplary embodiment, the applying the correction to the brake command based on the simulator temperature measurement may comprise combining the pedal effort measurement and the pedal travel measurement to determine a relationship between the pedal effort measurement and the pedal travel measurement.

According to an exemplary embodiment, the applying the correction to the brake command based on the simulator temperature measurement may comprise determining whether the simulator temperature measurement is within a temperature action range, when the simulator temperature measurement is within the temperature action range, determining whether the relationship between the pedal effort measurement and the pedal travel measurement is within predetermined parameters, and, when the relationship between the pedal effort measurement and the pedal travel measurement is within the predetermined parameters, applying the correction to the brake command based on the simulator temperature measurement.

According to an exemplary embodiment, the applying the correction to the brake command based on the simulator temperature measurement may comprise determining whether the simulator temperature measurement is within a temperature action range, when the simulator temperature measurement is within the temperature action range, determining whether the relationship between the pedal effort measurement and the pedal travel measurement is within predetermined parameters, when the relationship between the pedal effort measurement and the pedal travel measurement is within the predetermined parameters, determining whether a brake apply rate is within a tuned parameter, wherein the brake apply rate may be a rate at which a brake is applied, and, when the brake apply rate is within the tuned parameter, applying the correction to the brake command based on the simulator temperature measurement.

According to an exemplary embodiment, the actuation function may comprise performing one or more of a set of one or more physical operations required to decelerate the vehicle based on the final brake command.

According to an exemplary embodiment, the one or more physical operations may comprise applying a brake torque based on the final brake command.

According to an exemplary embodiment, the brake command may be a degree of braking a driver is requesting.

According to an object of the present disclosure, a system for compensating for a change in a brake pedal effort to brake pedal travel relationship due to temperature in an electronically-controlled braking system is provided. The system may comprise a vehicle. The vehicle may comprise a pedal effort sensor configured to measure a pedal effort measurement, a pedal travel sensor configured to measure a pedal travel measurement, a simulator temperature sensor configured to measure a simulator sensor measurement of a pedal feel simulator; and a computing device, comprising a processor and a memory, configured to store programming instructions that, when executed by the processor, cause the processor to perform a sensing function when a function to decelerate the vehicle is applied. The sensing function may comprise measuring the pedal effort measurement, using the pedal effort sensor, measuring the pedal travel measurement, using the pedal travel sensor, and measuring the simulator temperature measurement, using the simulator temperature sensor. The programming instructions, when executed by the processor, may be configured to cause the processor to perform a processing function. The processing function may comprise calculating a brake command, applying a correction to the brake command based on the simulator temperature measurement, generating a final brake command, and outputting the final brake command. The programming instructions, when executed by the processor, may be configured to cause the processor to perform an actuation function based on the final brake command.

According to an exemplary embodiment, the applying the correction to the brake command based on the simulator temperature measurement may comprise combining the pedal effort measurement and the pedal travel measurement to determine a relationship between the pedal effort measurement and the pedal travel measurement.

According to an exemplary embodiment, the applying the correction to the brake command based on the simulator temperature measurement may comprise determining whether the simulator temperature measurement is within a temperature action range, when the simulator temperature measurement is within the temperature action range, determining whether the relationship between the pedal effort measurement and the pedal travel measurement is within predetermined parameters, and, when the relationship between the pedal effort measurement and the pedal travel measurement is within the predetermined parameters, applying the correction to the brake command based on the simulator temperature measurement.

According to an exemplary embodiment, the applying the correction to the brake command based on the simulator temperature measurement may comprise determining whether the simulator temperature measurement is within a temperature action range, when the simulator temperature measurement is within the temperature action range, determining whether the relationship between the pedal effort measurement and the pedal travel measurement is within predetermined parameters, when the relationship between the pedal effort measurement and the pedal travel measurement is within the predetermined parameters, determining whether a brake apply rate is within a tuned parameter, wherein the brake apply rate may be a rate at which a brake is applied, and, when the brake apply rate is within the tuned parameter, applying the correction to the brake command based on the simulator temperature measurement.

According to an exemplary embodiment, the actuation function may comprise performing one or more of a set of one or more physical operations required to decelerate the vehicle based on the final brake command.

According to an exemplary embodiment, the one or more physical operations may comprise applying a brake torque based on the final brake command.

According to an exemplary embodiment, the brake command may be a degree of braking a driver is requesting.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 illustrates a method for compensating for brake pedal effort to travel change due to temperature in an electronically-controlled braking system , according to an exemplary embodiment of the present disclosure;

FIG. 2 illustrates a method for performing a processing function, according to an exemplary embodiment of the present disclosure;

FIG. 3 illustrates a method for performing a processing function, according to an exemplary embodiment of the present disclosure;

FIG. 4 illustrates a method for performing a processing function, according to an exemplary embodiment of the present disclosure;

FIG. 6 illustrates example elements of a computing device, according to an exemplary embodiment of the present disclosure; and

FIG. 7 illustrates an example architecture of a vehicle, according to an exemplary embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Hereinafter, some embodiments of the present disclosure will be described in detail with reference to the exemplary drawings. In the drawings, the same reference numerals will be used throughout to designate the same or equivalent elements. In addition, a detailed description of well-known features or functions will be ruled out in order not to unnecessarily obscure the gist of the present disclosure.

Systems and methods are provided for compensating for increasing effort with decreasing temperatures in an electronically-controlled braking system due to material property changes of a pedal feel simulator by modifying a driver brake command.

For braking systems, elastomeric component hardness changes with temperature, and the feeling spring and/or damper modulus changes with temperature. Additionally, brake fluid viscosity changes with temperature, affecting simulated pedal feel due to changes in fluid flow dynamics. Increased viscosity increases resistance to flow in a hydraulic pedal feel simulator, thus changing the effort to pedal travel during brake pedal applications, and reduced viscosity reduces resistance to pedal motion.

Many electronically-controlled braking systems utilize pedal travel as a component of calculating a driver brake command in order to decelerate a vehicle. During control of a vehicle, a driver may perceive changes in effort as an indication of a braking system abnormality or fault and may be dissatisfied. These changes in effort due to changes in temperature may be of a much greater magnitude than changes of effort that may occur with a conventional mechanically actuated braking system.

According to an exemplary embodiment, a software algorithm may be incorporated into a braking control algorithm in an electronically-controlled braking system and/or any other braking system that generates a driver brake command and utilizes a feel simulator or mechanism.

According to an exemplary embodiment, the software algorithm compensates for changes in the relationship between pedal effort and pedal travel that may occur due to material changes within the feel simulator system primarily due to changes in temperature by modifying driver brake commands in order to compensate for increasing or decreasing pedal effort due to material changes in the simulator system.

According to an exemplary embodiment, the compensation keeps a deceleration pedal effort to within a defined tolerance since an increased and/or decreased pedal effort for deceleration may cause driver dissatisfaction.

Many electronically-controlled braking systems utilize brake pedal travel (e.g., pedal travel, input rod motion, pedal rotation, and/or other similar motion) as a component of a braking intention command. The relationship between pedal travel and effort is a tuned relationship typically due to springs and dampers within the mechanical input control device that may be arranged as a pedal feel simulator or similar device. The purpose of this is to cause a proportional increase in pedal effort with an increasing pedal travel.

The relationship between brake pedal effort to pedal travel is a critical relationship that is tuned to result in a controllable, predictable, and repeatable feeling in all braking systems. In an electronically-controlled braking system, the pedal effort to pedal travel relationship may be created with a pedal feel simulator or similar device. The construction and application of this simulator may result in susceptibility to material property change due to increasing and/or decreasing temperatures.

Changing of material properties may affect the pedal effort to pedal travel relationship which may result in lower or higher effort in order to achieve a pedal travel. As pedal travel is a primary brake command input, this may result in a higher or lower effort in order to achieve a vehicle deceleration. The driver may perceives changes in effort as an indication of a braking system abnormality or a fault and may be dissatisfied. Likewise, increasing pedal effort may result in a feeling of braking ineffectiveness and the driver may be dissatisfied.

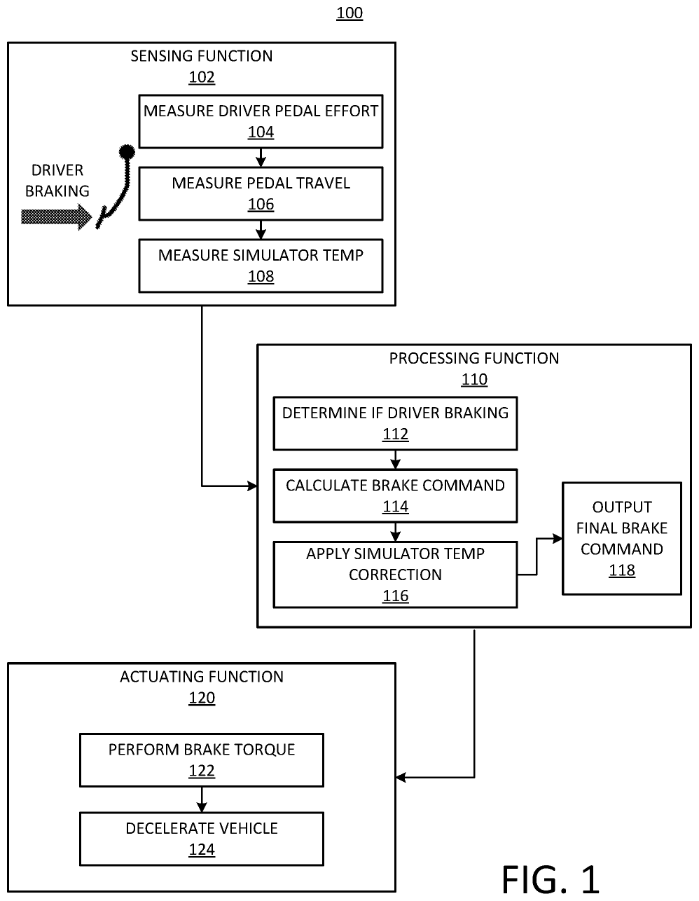

Referring now to FIG. 1, a method 100 for compensating for brake pedal effort to travel change due to temperature in an electronically-controlled braking system is illustratively depicted, in accordance with an exemplary embodiment of the present disclosure.

At 102, the braking system of the present disclosure may perform a sensing function during driver braking (i.e., when a driver performs a function to decelerate the vehicle). According to an exemplary embodiment, during the sensing function, the braking system of the present disclosure may utilize sensing elements tied to a driver braking input and a simulator temperature.

According to an exemplary embodiment, during the sensing function, at 104, a pedal effort sensor may measure a driver's pedal effort, or an equivalent measurement. According to an exemplary embodiment, pedal effort data may be a measurement or calculation of how much pedal effort is being applied by the driver. The pedal effort may be a direct measurement, a calculation based on one or more other measurements, or stored in a lookup table based on one or more measurements such as, e.g., pedal travel.

According to an exemplary embodiment, during the sensing function, at 106, a pedal travel sensor may measure a pedal travel measurement, or an equivalent measurement. According to an exemplary embodiment, pedal travel data may be a direct measurement or a calculation based on another measurement to determine how far the brake pedal has been applied.

According to an exemplary embodiment, during the sensing function, at 108, a simulator temperature sensor may provide a measure of a simulator temperature. According to an exemplary embodiment, the simulator temperature may be a direct or indirect measurement or calculation of a temperature of the pedal feel simulator.

At 110, the braking system of the present disclosure may perform a processing function based on the measurements/data sensed during the sensing function, at 102.

According to an exemplary embodiment, during the processing function, at 112, based on the sensing elements, the braking system of the present disclosure may identify whether the driver is braking (attempting to decelerate) the vehicle. When it is determined that the driver is braking the vehicle, a driver braking signal may be generated and/or a driver braking signal may be used to determine that the driver is braking the vehicle. According to an exemplary embodiment, the driver braking signal may be an input used to determine whether the driver is requesting a braking event and may be a single signal or a combination of signals.

According to an exemplary embodiment, during the processing function, at 114, a brake command may be calculated. According to an exemplary embodiment, the brake command may define what degree of (i.e., how much) braking the driver is requesting based on the sensing elements, one or more additional calculations, and/or or a look up table, among other suitable means of calculating the brake command. According to an exemplary embodiment, the driver braking signal may be input into a brake command calculation in order to create a final brake command that may be used by a brake actuation system in order to decelerate the vehicle.

According to an exemplary embodiment, during the processing function, at 116, a simulator temperature correction may be applied. According to an exemplary embodiment, in order to apply the simulator temperature correction, the sensing elements may be considered in order to utilize a calculation or look up table in order to generate and/or modify a final brake command in order to compensate for a changing simulator temperature.

According to an exemplary embodiment, during the processing function, at 118, the final brake comment is output. According to an exemplary embodiment, the final brake command may be the output of the processing function and is the brake command which is passed down the braking system of the present disclosure during the actuating function.

The final brake command may be a combination of the brake command calculation and the correction to the simulator temperature correction application. The final brake command may be the brake command calculation with no modification if the process was exited at any time. The final brake command may be the final output of the braking system of the present disclosure and may be configured to be transmitted to an electronically-controlled braking system.

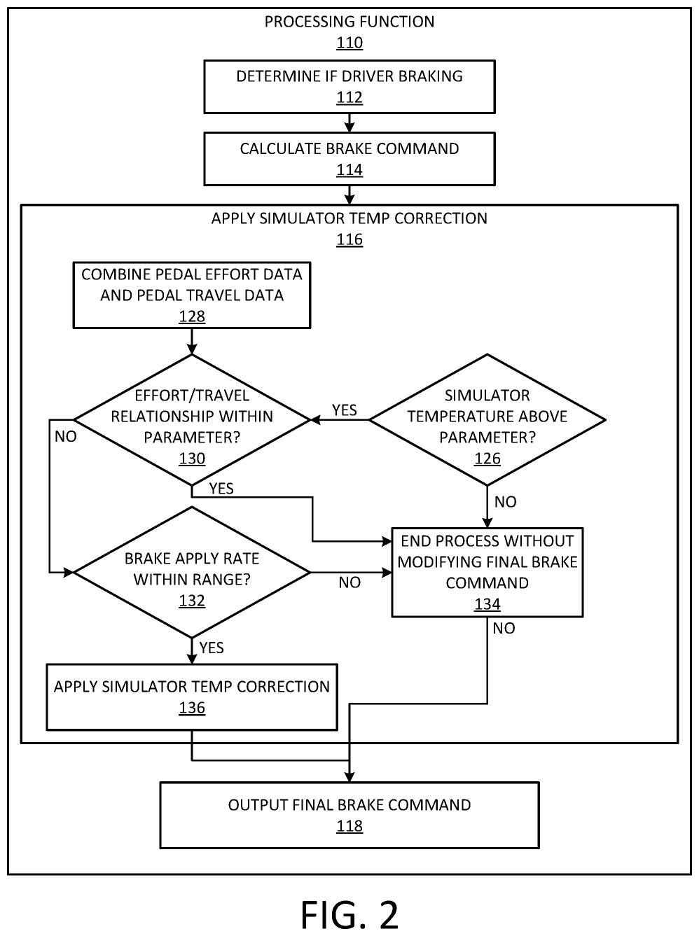

Applying the simulator temperature correction, at 116, is shown, in more detail, in FIG. 2.

According to an exemplary embodiment, at 126, actual, calculated, or modeled simulator temperature is analyzed and compared to a tunable temperature action range (parameter) in order to determine whether the simulator temperature is within the temperature action range. If the simulator temperature is not within the temperature action range, then, at 134, the process ends without modifying the final brake command and the final brake command, at 118, is output.

According to an exemplary embodiment, if the simulator temperature is within the temperature action range, the process continues, to step 130. According to an exemplary embodiment, the temperature action range may be determined for one or more characteristics for a specific application. It is noted, however, that other means of determining the temperature action range may be incorporated, while maintaining the spirit and functionality of the present disclosure.

According to an exemplary embodiment, the braking system of the present disclosure is configured to compensate for changes in brake pedal simulator effort in relation to changes in pedal travel due to changes in temperature by modifying the final brake command. According to an exemplary embodiment, pedal effort data and pedal travel data may be combined, at 128, in order to determine a relationship (measured and/or calculated) between the pedal effort data and the pedal travel data. According to an exemplary embodiment, the pedal effort data and the pedal travel data are expected to have a regular and predictable relationship during normal operation and may have a different relationship during certain conditions such as, e.g., low ambient temperature.

According to an exemplary embodiment, the relationship between the pedal effort and the pedal travel may be monitored using one or more system sensors. Alternatively, the braking system of the present disclosure may have a known relationship of pedal effort to pedal travel a known change due to temperature from measured or modeled data stored within memory (e.g., a lookup table, matrix, or equation).

At 130, it is determined whether the relationship between the pedal effort and the pedal travel is within expected, normal parameters (e.g., within predetermined parameters).

According to an exemplary embodiment, the relationship between the pedal effort and the pedal travel may only be available if the measurement of the pedal effort and the pedal travel is utilized. If a stored relationship between the pedal effort and the pedal travel is utilized, this comparison is not possible and this decision would not be used.

If the relationship between the pedal effort and the pedal travel is within the expected normal parameters, then, at 134, the process ends without modifying the final brake command and the final brake command, at 118, is output.

If the relationship between the pedal effort and the pedal travel is not within the expected normal parameters, the process continues, to step 132.

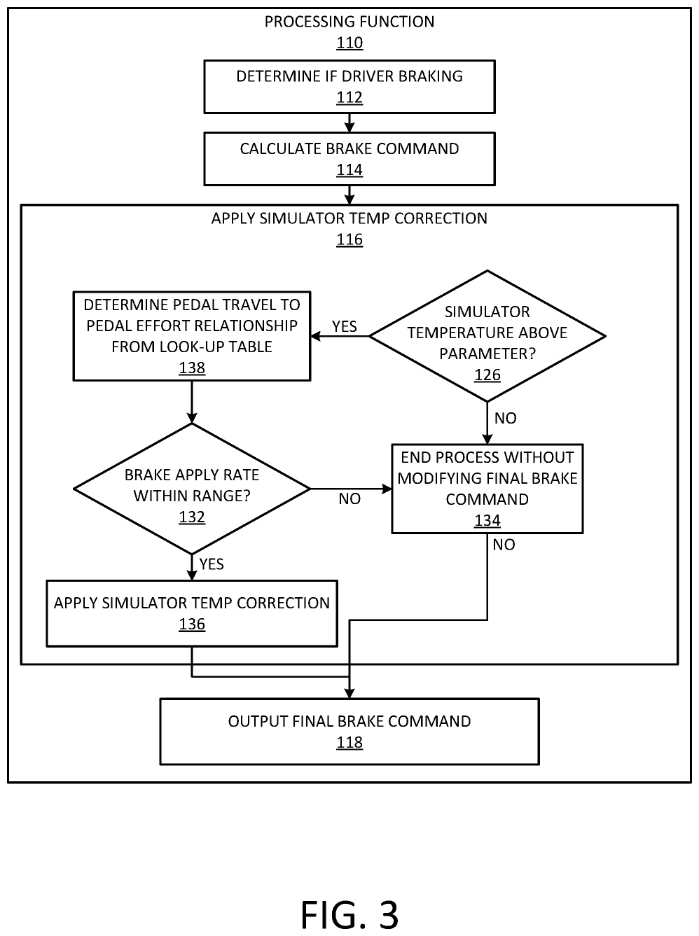

According to an exemplary embodiment, a temperature-dependent relationship between the pedal travel and the pedal effort may be known and may be referenced, using, e.g., a look-up table. In this embodiment, as shown in FIG. 3, rather than determining whether the relationship between the pedal effort and the pedal travel is within expected, a temperature-dependent relationship between the pedal effort and the pedal travel may be determined, at 138, using a database of known temperature-dependent pedal travel to pedal effort relationships.

According to an exemplary embodiment, the braking system of the present disclosure may be configured to monitor a brake apply rate and compare the brake apply rate to a tuned parameter (range). According to an exemplary embodiment, at 132, it is determined whether the brake apply rate is within the tuned parameter. According to an exemplary embodiment, the brake apply rate is the rate at which the brake is applied. Determining whether the brake apply rate is within the tuned parameter may be a check to determine if the driver has made a very fast or slow application of the brake(s), which may cause the combined pedal effort data and pedal travel data to fall outside of the expected relationship due to a design of the brake simulator or due to other factors such as, e.g., the measurement method. According to an exemplary embodiment, the tuning parameter may be specific to an application and may tuned accordingly. According to an exemplary embodiment, the determining whether the brake apply rate is within the tuned parameter may be negated.

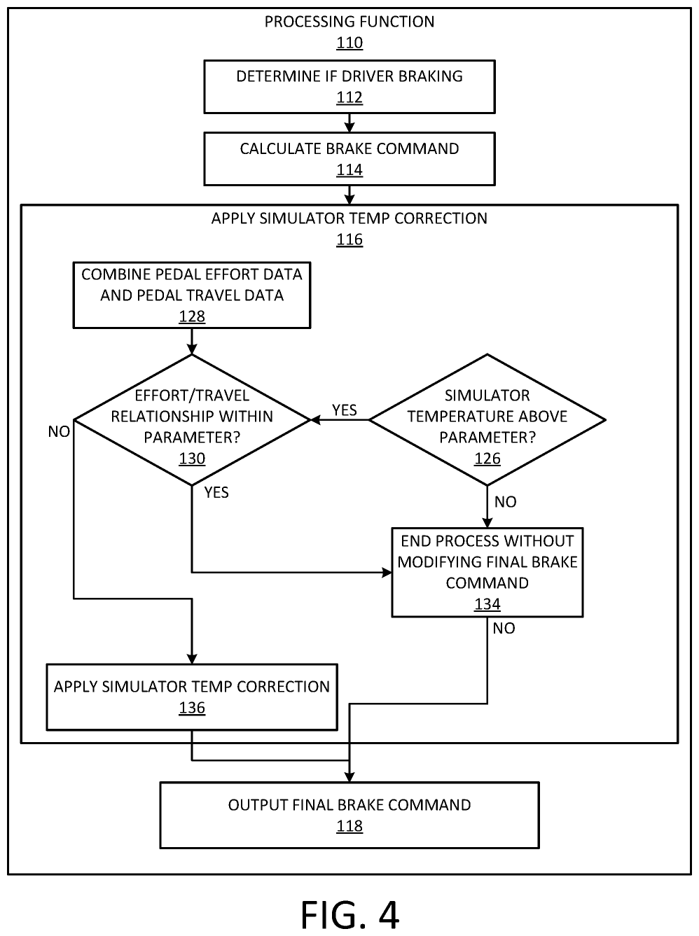

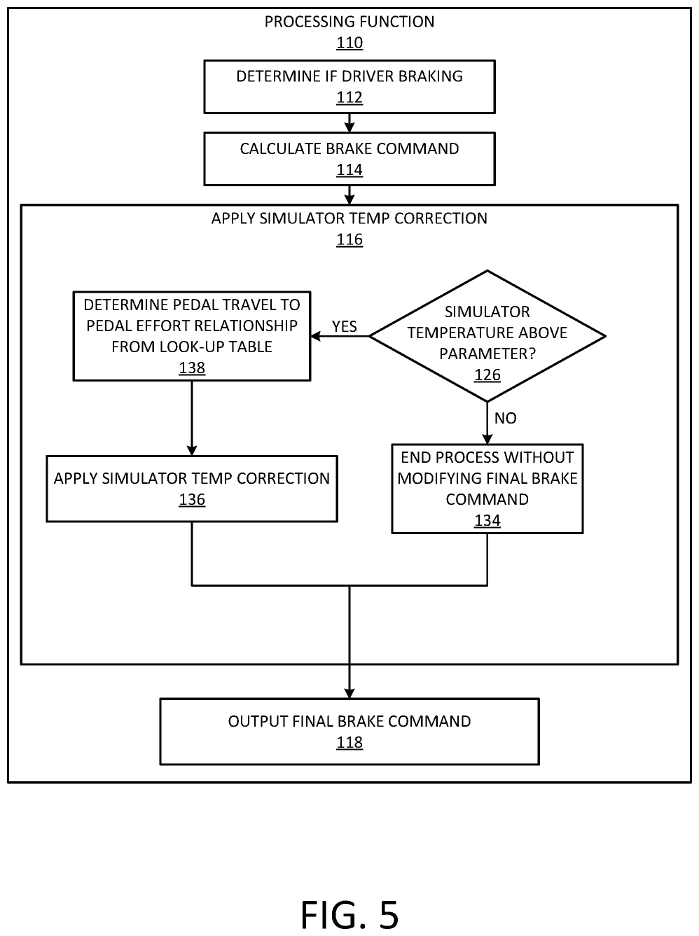

If the brake apply rate is not within the tuned parameter (e.g., if the brake was applied faster or slower than the parameter indicates), then, at 134, the process ends without modifying the final brake command and the final brake command, at 118, is output. A very high or very low brake apply rate could change the pedal effort to pedal travel relationship in part due to simulator component properties. According to an exemplary embodiment, if the brake apply rate is not within the tuned parameter, the braking system may be configured to determine, on a case-by-case basis, whether or not to utilize the brake apply rate (as shown, e.g., in FIG. 4), and/or what tuned parameter should be used. According to an exemplary embodiment, when a temperature-dependent relationship between the pedal travel and the pedal effort is known and may be referenced, using, e.g., a look-up table, determining whether the brake apply rate is within the tuned parameter may be avoided, as shown in the exemplary embodiment of FIG. 5.

If the brake apply rate is within the tuned parameter, then, at 136, a correction to the brake command based on the simulator temperature is applied, generating the final brake command. According to an exemplary embodiment, a mathematical multiplier and/or a lookup table may be used to modify the brake command in order to compensate for temperature induced change in the relationship of the pedal effort to the pedal travel.

According to an exemplary embodiment, correcting the simulator temperature may comprise determining a corrected simulator temperature. Determining the corrected simulator temperature may comprise utilizing a lookup table, a calculated multiplier, and/or some combination thereof that considers the simulator temperature and the properties of the brake simulator and may increase or decrease the brake command calculation by applying a correction value and/or multiplier in order to keep the pedal effort within a defined range. According to an exemplary embodiment, the calculation may be specific to an application and may be tuned for the specific application.

According to an exemplary embodiment, once the final brake command is updated, the final brake command is output, at 118.

At 120, the braking system of the present disclosure may perform an actuating function based on the final brake command. According to an exemplary embodiment, the actuating function may be a set of one or more physical operations required to decelerate the vehicle based on the final brake command.

According to an exemplary embodiment, during the actuating function, at 122, brake torque may be applied. Brake torque is a portion of vehicle deceleration provided by vehicle friction braking elements.

According to an exemplary embodiment, the braking torque may comprise regenerative braking torque (regen torque). Regen torque is a portion of vehicle deceleration provided by electrical regeneration on hybrid and/or electric vehicles caused by a drive motor being used as a generator to reclaim forward motion and convert it to electrical energy.

According to an exemplary embodiment, the brake torque leads to vehicle deceleration, at 124. Vehicle deceleration is the final result of the braking process and is the expected result of the driver braking input.

According to an exemplary embodiment, the brake pedal of the present disclosure may be replaced by a hand lever and/or other suitable breaking mechanism.

According to an exemplary embodiment, any vehicle utilizing an electronically-controlled brake systems with a feeling simulator which may be affected by temperature may be incorporated into the present disclosure, while maintaining the spirit and functionality of the present disclosure.

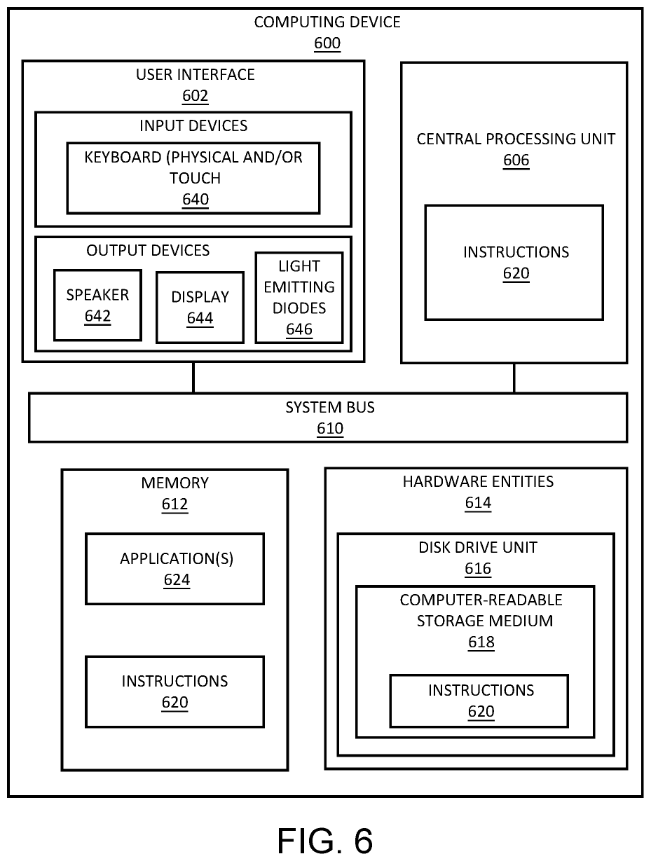

Referring now to FIG. 6, an illustration of an example architecture for a computing device 600 is provided. According to an exemplary embodiment, one or more functions of the present disclosure may be implemented by a computing device such as, e.g., computing device 600 or a computing device similar to computing device 600.

The hardware architecture of FIG. 6 represents one example implementation of a representative computing device configured to perform one or more methods and means for compensating for brake pedal effort to travel change due to temperature in an electronically-controlled braking system, as described herein. As such, the computing device 600 of FIG. 6 implements at least a portion of the method(s) described herein (e.g., method 100 of FIG. 1).

Some or all components of the computing device 600 may be implemented as hardware, software, and/or a combination of hardware and software. The hardware may comprise, but is not limited to, one or more electronic circuits. The electronic circuits may comprise, but are not limited to, passive components (e.g., resistors and capacitors) and/or active components (e.g., amplifiers and/or microprocessors). The passive and/or active components may be adapted to, arranged to, and/or programmed to perform one or more of the methodologies, procedures, or functions described herein.

As shown in FIG. 6, the computing device 600 may comprise a user interface 602, a Central Processing Unit (“CPU”) 606, a system bus 610, a memory 612 connected to and accessible by other portions of computing device 600 through system bus 610, and hardware entities 614 connected to system bus 610. The user interface may comprise input devices and output devices, which may be configured to facilitate user-software interactions for controlling operations of the computing device 600. The input devices may comprise, but are not limited to, a physical and/or touch keyboard 640. The input devices may be connected to the computing device 600 via a wired or wireless connection (e.g., a Bluetooth® connection). The output devices may comprise, but are not limited to, a speaker 642, a display 644, and/or light emitting diodes 646.

At least some of the hardware entities 614 may be configured to perform actions involving access to and use of memory 612, which may be a Random Access Memory (RAM), a disk driver and/or a Compact Disc Read Only Memory (CD-ROM), among other suitable memory types. Hardware entities 614 may comprise a disk drive unit 616 comprising a computer-readable storage medium 618 on which may be stored one or more sets of instructions 620 (e.g., programming instructions such as, but not limited to, software code) configured to implement one or more of the methodologies, procedures, or functions described herein. The instructions 620 may also reside, completely or at least partially, within the memory 612 and/or within the CPU 606 during execution thereof by the computing device 600.

The memory 612 and the CPU 606 may also constitute machine-readable media. The term “machine-readable media”, as used here, refers to a single medium or multiple media (e.g., a centralized or distributed database, and/or associated caches and servers) that store the one or more sets of instructions 620. The term “machine-readable media”, as used here, also refers to any medium that is capable of storing, encoding or carrying a set of instructions 620 for execution by the computing device 600 and that cause the computing device 600 to perform any one or more of the methodologies of the present disclosure.

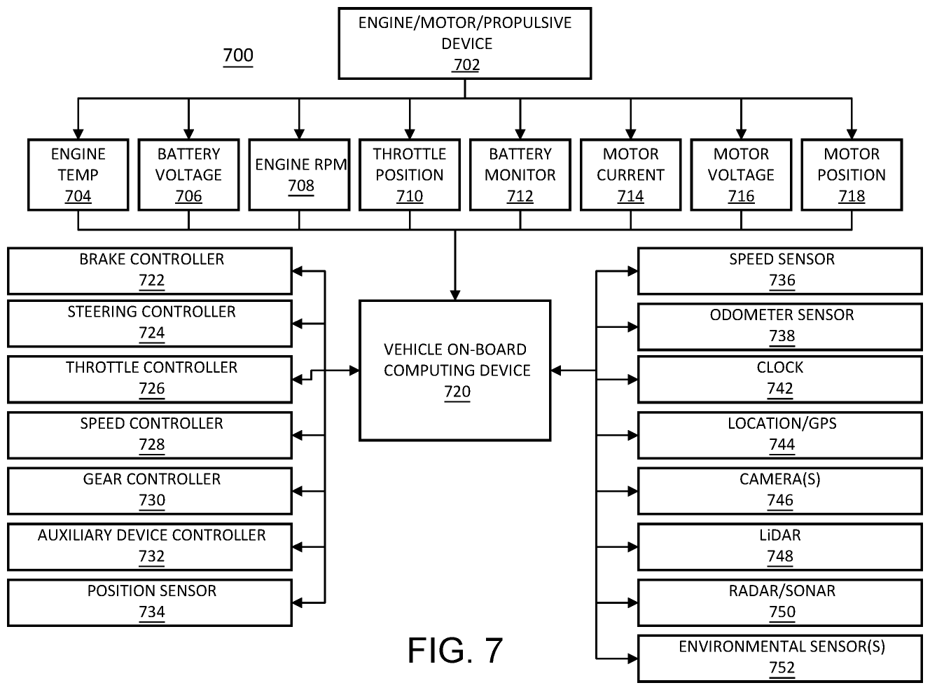

Referring now to FIG. 7, an example vehicle system architecture 700 for a vehicle is provided, in accordance with an exemplary embodiment of the present disclosure.

As shown in FIG. 7, the vehicle system architecture 700 may comprise an engine, motor or propulsive device (e.g., a thruster) 702 and various sensors 704-718 for measuring various parameters of the vehicle system architecture 700. In gas-powered or hybrid vehicles having a fuel-powered engine, the sensors 704-718 may comprise, for example, an engine temperature sensor 704, a battery voltage sensor 706, an engine Rotations Per Minute (RPM) sensor 708, and/or a throttle position sensor 710. If the vehicle is an electric or hybrid vehicle, then the vehicle may comprise an electric motor, and accordingly may comprise sensors such as a battery monitoring system 712 (to measure current, voltage and/or temperature of the battery), motor current 714 and voltage 716 sensors, and motor position sensors such as resolvers and encoders 718.

Operational parameter sensors that are common to both types of vehicles may comprise, for example: a position sensor 734 such as an accelerometer, gyroscope and/or inertial measurement unit; a speed sensor 736; and/or an odometer sensor 738. The vehicle system architecture 700 also may comprise a clock 742 that the system uses to determine vehicle time and/or date during operation. The clock 742 may be encoded into the vehicle on-board computing device 720, it may be a separate device, or multiple clocks may be available.

The vehicle system architecture 700 also may comprise various sensors that operate to gather information about the environment in which the vehicle is traveling. These sensors may comprise, for example: a location sensor 744 (for example, a Global Positioning System (GPS) device); object detection sensors such as one or more cameras 746; a LiDAR sensor system 748; and/or a RADAR and/or a sonar system 750. The sensors also may comprise environmental sensors 752 such as, e.g., a humidity sensor, a precipitation sensor, a light sensor, and/or ambient temperature sensor. The object detection sensors may be configured to enable the vehicle system architecture 700 to detect objects that are within a given distance range of the vehicle in any direction, while the environmental sensors 752 may be configured to collect data about environmental conditions within the vehicle's area of travel.

During operations, information may be communicated from the sensors to an on-board computing device 720 (e.g., computing device 600 of FIG. 6). The on-board computing device 720 may be configured to analyze the data captured by the sensors and/or data received from data providers and may be configured to optionally control operations of the vehicle system architecture 700 based on results of the analysis. For example, the on-board computing device 720 may be configured to control: braking via a brake controller 722; direction via a steering controller 724; speed and acceleration via a throttle controller 726 (in a gas-powered vehicle) or a motor speed controller 728 (such as a current level controller in an electric vehicle); a differential gear controller 730 (in vehicles with transmissions); and/or other controllers. The brake controller 722 may comprise a pedal effort sensor, pedal effort sensor, and/or simulator temperature sensor, as described herein.

Geographic location information may be communicated from the location sensor 744 to the on-board computing device 720, which may then access a map of the environment that corresponds to the location information to determine known fixed features of the environment such as streets, buildings, stop signs and/or stop/go signals. Captured images from the cameras 746 and/or object detection information captured from sensors such as LiDAR 748 may be communicated from those sensors to the on-board computing device 720. The object detection information and/or captured images may be processed by the on-board computing device 720 to detect objects in proximity to the vehicle. Any known or to be known technique for making an object detection based on sensor data and/or captured images may be used in the embodiments disclosed in this document.

The above description is merely illustrative of the technical spirit of the present disclosure, and those skilled in the art to which the present disclosure belongs may make various modifications and changes without departing from the essential features of the present disclosure.

Although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Thus, the embodiments disclosed in the present disclosure are not intended to limit the technology spirit of the present disclosure, but are intended to describe the present disclosure, and the scope of the technical spirit of the present disclosure is not limited by these embodiments. The scope of protection of the present disclosure should be interpreted by the appended claims, and all technical spirits within the scope equivalent thereto should be interpreted as being included in the scope of the present disclosure.

What is claimed is:

1. A method for compensating for a change in a brake pedal effort to brake pedal travel relationship due to temperature in an electronically-controlled braking system, the method comprising:
performing, using a computing device of a vehicle, a sensing function when a function to
decelerate the vehicle is applied, wherein the sensing function comprises:
measuring a pedal effort measurement, using a pedal effort sensor;
measuring a pedal travel measurement, using a pedal travel sensor; and
measuring a simulator temperature measurement of a pedal feel simulator, using a simulator temperature sensor;
performing, using the computing device, a processing function, wherein the processing function comprises:
calculating a brake command;
applying a correction to the brake command based on the simulator temperature measurement, generating a final brake command; and
outputting the final brake command; and
performing, using the computing device, an actuation function based on the final brake command.

2. The method of claim 1, wherein the applying the correction to the brake command based on the simulator temperature measurement comprises, using the computing device:
combining the pedal effort measurement and the pedal travel measurement to determine a relationship between the pedal effort measurement and the pedal travel measurement.

3. The method of claim 2, wherein the applying the correction to the brake command based on the simulator temperature measurement comprises, using the computing device:
determining whether the simulator temperature measurement is within a temperature action range;
when the simulator temperature measurement is within the temperature action range, determining whether the relationship between the pedal effort measurement and the pedal travel measurement is within predetermined parameters; and
when the relationship between the pedal effort measurement and the pedal travel measurement is within the predetermined parameters, applying the correction to the brake command based on the simulator temperature measurement.

4. The method of claim 2, wherein the applying the correction to the brake command based on the simulator temperature measurement comprises, using the computing device:
determining whether the simulator temperature measurement is within a temperature action range;
when the simulator temperature measurement is within the temperature action range, determining whether the relationship between the pedal effort measurement and the pedal travel measurement is within predetermined parameters;
when the relationship between the pedal effort measurement and the pedal travel measurement is within the predetermined parameters, determining whether a brake apply rate is within a tuned parameter,
wherein the brake apply rate is a rate at which a brake is applied; and
when the brake apply rate is within the tuned parameter, applying the correction to the brake command based on the simulator temperature measurement.

5. The method of claim 1, wherein the actuation function comprises:
performing one or more of a set of one or more physical operations required to decelerate the vehicle based on the final brake command.

6. The method of claim 1, wherein the one or more physical operations comprise:
applying a brake torque based on the final brake command.

7. The method of claim 1, wherein the brake command is a degree of braking a driver is requesting.

8. A system for compensating for a change in a brake pedal effort to brake pedal travel relationship due to temperature in an electronically-controlled braking system, the system comprising:
a vehicle, comprising:
a pedal effort sensor configured to measure a pedal effort measurement;
a pedal travel sensor configured to measure a pedal travel measurement;
a simulator temperature sensor configured to measure a simulator sensor measurement of a pedal feel simulator; and
a processor configured to:
perform a sensing function when a function to decelerate the vehicle is applied, wherein the sensing function comprises:
measuring the pedal effort measurement, using the pedal effort sensor;
measuring the pedal travel measurement, using the pedal travel sensor; and
measuring the simulator temperature measurement, using the simulator temperature sensor;
perform a processing function, wherein the processing function comprises:
calculating a brake command;
applying a correction to the brake command based on the simulator temperature measurement, generating a final brake command; and
outputting the final brake command; and
perform an actuation function based on the final brake command.

9. The system of claim 8, wherein the applying the correction to the brake command based on the simulator temperature measurement comprises:
combining the pedal effort measurement and the pedal travel measurement to determine a relationship between the pedal effort measurement and the pedal travel measurement.

10. The system of claim 9, wherein the applying the correction to the brake command based on the simulator temperature measurement comprises:
determining whether the simulator temperature measurement is within a temperature action range;
when the simulator temperature measurement is within the temperature action range, determining whether the relationship between the pedal effort measurement and the pedal travel measurement is within predetermined parameters; and
when the relationship between the pedal effort measurement and the pedal travel measurement is within the predetermined parameters, applying the correction to the brake command based on the simulator temperature measurement.

11. The system of claim 9, wherein the applying the correction to the brake command based on the simulator temperature measurement comprises:
determining whether the simulator temperature measurement is within a temperature action range;
when the simulator temperature measurement is within the temperature action range, determining whether the relationship between the pedal effort measurement and the pedal travel measurement is within predetermined parameters;
when the relationship between the pedal effort measurement and the pedal travel measurement is within the predetermined parameters, determining whether a brake apply rate is within a tuned parameter,
wherein the brake apply rate is a rate at which a brake is applied; and
when the brake apply rate is within the tuned parameter, applying the correction to the brake command based on the simulator temperature measurement.

12. The system of claim 8, wherein the actuation function comprises:
performing one or more of a set of one or more physical operations required to decelerate the vehicle based on the final brake command.

13. The system of claim 8, wherein the one or more physical operations comprise:
applying a brake torque based on the final brake command.

14. The system of claim 8, wherein the brake command is a degree of braking a driver is requesting.

15. A system for compensating for a change in a brake pedal effort to brake pedal travel relationship due to temperature in an electronically-controlled braking system, the system comprising:
a vehicle, comprising:
a pedal effort sensor configured to measure a pedal effort measurement;
a pedal travel sensor configured to measure a pedal travel measurement;
a simulator temperature sensor configured to measure a simulator sensor measurement of a pedal feel simulator; and
a computing device, comprising a processor and a memory, configured to store programming instructions that, when executed by the processor, cause the processor to:
perform a sensing function when a function to decelerate the vehicle is applied, wherein the sensing function comprises:
measuring the pedal effort measurement, using the pedal effort sensor;
measuring the pedal travel measurement, using the pedal travel sensor; and
measuring the simulator temperature measurement, using the simulator temperature sensor;
perform a processing function, wherein the processing function comprises:
calculating a brake command;
applying a correction to the brake command based on the simulator temperature measurement, generating a final brake command; and
outputting the final brake command; and
perform an actuation function based on the final brake command.

16. The system of claim 15, wherein the applying the correction to the brake command based on the simulator temperature measurement comprises:
combining the pedal effort measurement and the pedal travel measurement to determine a relationship between the pedal effort measurement and the pedal travel measurement.

17. The system of claim 16, wherein the applying the correction to the brake command based on the simulator temperature measurement comprises:
determining whether the simulator temperature measurement is within a temperature action range;
when the simulator temperature measurement is within the temperature action range, determining whether the relationship between the pedal effort measurement and the pedal travel measurement is within predetermined parameters; and
when the relationship between the pedal effort measurement and the pedal travel measurement is within the predetermined parameters, applying the correction to the brake command based on the simulator temperature measurement.

18. The system of claim 16, wherein the applying the correction to the brake command based on the simulator temperature measurement comprises:
determining whether the simulator temperature measurement is within a temperature action range;
when the simulator temperature measurement is within the temperature action range, determining whether the relationship between the pedal effort measurement and the pedal travel measurement is within predetermined parameters;
when the relationship between the pedal effort measurement and the pedal travel measurement is within the predetermined parameters, determining whether a brake apply rate is within a tuned parameter,
wherein the brake apply rate is a rate at which a brake is applied; and
when the brake apply rate is within the tuned parameter, applying the correction to the brake command based on the simulator temperature measurement.

19. The system of claim 15, wherein the actuation function comprises:
performing one or more of a set of one or more physical operations required to decelerate the vehicle based on the final brake command.

20. The system of claim 15, wherein the one or more physical operations comprise:
applying a brake torque based on the final brake command.
